(19) United States
(12) Patent Application Publication
(10) Pub. No.: US 2013/0187755 A1
(43) Pub. Date: Jul. 25, 2013

(54) SYSTEMS AND METHODS FOR MANAGING SHOPPING CART AND OTHER WHEELED CONVEYANCE ASSETS

(71) Applicants: Eugene Joseph Rogers, Mission Viejo, CA (US); Thomas Daniel Anderson, Mission Viejo, CA (US); Femanda Hui, San Djego, CA (US)

(72) Inventors: Eugene Joseph Rogers, Mission Viejo, CA (US); Thomas Daniel Anderson, Mission Viejo, CA (US); Femanda Hui, San Djego, CA (US)

(21) Appl. No.: 13/581,758

(22) PCT Filed: Apr. 7, 2010
(86) PCT No.: PCT/US2010/001044

§ 371 Date: Mar. 29, 2013

Related U.S. Application Data
(60) Provisional application No. 61/202,790, filed on Apr. 6, 2009.

(51) Int. Cl. G08B 13/24

(52) U.S. Cl. CPC G08B 13/2451
USPC 340/5.61

(57) ABSTRACT

The inventive subject matter relates to systems and methods relating to managing shopping cart and other wheeled conveyance assets of an enterprise. More particularly, one aspect of the inventive subject matter relates to using radio frequency identification (RFID) tags and control units to track, manage, and maintain shopping cart and other wheeled conveyance assets of a enterprise, in order to immobilize such wheeled conveyance if an unauthorized attempt is made to move it outside a prescribed use area into a restricted area. In a further aspect of the inventive subject matter, said systems and methods permit authorized uses of such assets to take them into a restricted area.

This application claims the benefit of U.S. Provisional Patent Application No. 61/202,790, filed Apr. 6, 2009, the contents of which is hereby incorporated by reference in its entirety. This application is further related and complementary to U.S. patent application Ser. No. 11/703,207, filed Feb. 7, 2007, and its parent applications, the contents of which are hereby incorporated by reference in their entirety.

### BACKGROUND OF THE INVENTIVE SUBJECT MATTER

1. Field of Inventive Subject Matter

The inventive subject matter relates to systems and methods relating to managing shopping cart and other wheeled conveyance assets of an enterprise. More particularly, one aspect of the inventive subject matter relates to using radio frequency identification (RFID) tags and control units to track, manage, and maintain shopping cart and other wheeled conveyance assets of a enterprise, in order to immobilize such wheeled conveyance if an unauthorized attempt is made to move it outside a prescribed use area into a restricted area. In a further aspect of the inventive subject matter, said systems and methods permit authorized uses of such assets to take them into a restricted area.

2. Background

Asset management is very important as today's enterprises make efforts to streamline operations to reduce overall operation costs. However, currently there are few tools available that allow enterprises to accurately track, maintain, and properly distribute wheeled conveyance assets such as shopping carts.

### Technical Problems

A. “Unauthorized-Taking” Issues.

Most retail businesses provide store customers with shopping carts, push-carts, baby carriages, wheelchairs, or other similar wheeled conveyances for the convenience of such customers in transporting merchandise, children, or themselves through the stores and to customer vehicles. Other enterprises also have other wheeled conveyances which must be managed. One problem that many of these establishments experience is substantial financial burdens through the loss of such assets, be it through outright theft or simple unauthorized removal from the premises and negligent abandonment.

Relating to management of shopping carts in particular, nearly all of the prior art relates to this “unauthorized-taking” issue, and there are many similar systems for preventing removal of carts from a business premises. Thus, others have sought to solve the lost or stolen cart problem by providing means for automatically disabling, or immobilizing, the cart if it is being moved outside a prescribed use area.

One of the earliest such proposals is disclosed in U.S. Pat. No. 2,964,140, issued Dec. 13, 1960, to Brezny for “Anti-Theft Device for Carts”. Brezny proposed that one or more of the cart casters be equipped with a mechanism for inserting a pin into an opening in the wheel in the caster to lock the wheel against turning. Brezny provided a mechanism for actuating the locking pin into locking position in response to the caster being moved over a magnetic strip at the perimeter of the prescribed use area. A major disadvantage of the Brezny and similar locking systems is that such systems do not distinguish authorized from unauthorized uses.

Similarly, in U.S. Pat. No. 4,772,880, issued Sep. 20, 1988, Goldstein, et al. describe a system utilizing a clamp-on assembly which houses a battery-powered receiver for sensing when the cart leaves the area adjacent the business and includes means for disabling a wheel of the cart when the cart is outside the area.

In U.S. Pat. No. 5,315,290, issued May 24, 1994, Moreno, et al. describe a cart immobilizing mechanism responding to signals prescribing a permitted use area for the cart contained entirely within a wheel of the cart, and having a circuit board containing a radio frequency receiver, a decoder, and a logic driver; a solenoid device; configured so that when the receiver detects that the cart has been moved outside the prescribed use area, the solenoid device is energized to drive its armature into an opening in a non-rotating shaft supporting a wheel, thereby locking the wheel against rotation and immobilizing the cart. Moreno, et al. further requires use of coded transmitted signals, wherein sets of carts from two or more nearby stores can be supervised throughout different, but overlapping, use areas; each cart with a decoder associated with its receiver responds solely to the coded transmission from its store and not to the transmission of a different nearby store.

Another approach to cart immobilization is disclosed in U.S. Pat. No. 4,242,668, issued Dec. 30, 1980, to Herzog for “Cart Theft Prevention System”. Herzog's cart is immobilized by unlatching a support structure for the front wheels of the cart, allowing the front of the cart frame to fall down into contact with the ground. Unlatching of the front wheel structure is accomplished in response to a signal receiver detecting a signal from a transmitter at the exit of the prescribed use area or the receiver losing receipt of a signal which covers only the prescribed use area. A major disadvantage of the Herzog system lies in the rather extensive and complex modification required for the cart undercarriage.

Preventing removal of carts from a business premises continues to be the focus to date: for example, in U.S. Pat. No. 7,420,461, issued Sep. 2, 2008, Nebolon, et al. describe an electronic security and theft prevention system in which an alarm system detects when a vehicle such a shopping cart encounters an electronic barrier, including above-ground RF beacons together with underground antennas, that will selectively disable the vehicle and thereby prevent its removal from a defined area.

B. Regulatory Issues.

A second problem experienced by such establishments is an increasing regulatory burden as local jurisdictions and states establish laws regulating the use of shopping carts and the like, particularly the recovery of carts that have been taken from the business premises. This aspect of shopping cart management has been given little or no direct attention in the prior art, as essentially all existing systems rely on their solution to the “unauthorized-taking” problem described above to address this problem as well. Thus, the uniform solution to the governmental regulation issue has been to focus on developing more effective systems for preventing a cart from leaving the business premises.

While there are differences in the local factors that are taken into account by each jurisdiction considering the issue, there are common factors that appear repeatedly: abandoned shopping carts and other wheeled conveyances are considered to constitute a nuisance, create potential hazards to the health and safety of the public, and interfere with pedestrian and vehicular traffic as well as emergency services. When wrecked, dismantled and/or abandoned on public or private property, these create conditions that reduce property values, promote blight, and permit deterioration within the neighborhoods of the jurisdiction.

California is one state that has been at the forefront of regulating the use and recovery of shopping carts. California Business and Professions Code §22435.1 authorizes a city, county, or city and county to impound certain shopping carts, as specified, and declares the intent of the Legislature that the regulation constitutes a matter of statewide concern that shall be governed solely by these provisions. Under related §§22435-22435.7, municipalities have the authority to enact “illegally removed shopping cart” ordinances to address stores that use shopping carts. A number of municipalities in California have exercised this authority:

A. The City of Burbank passed a shopping cart ordinance requiring retailers to install an electronic containment system if the City observes five or more carts off store premises during a 24-hour period. Burbank Shopping Cart Containment Ordinance 3716.

B. The Pasadena Municipal Code Section 9.62.030, requires shopping carts to have a “physical containment system” i.e. a disabling device on all shopping carts which prevents them from being removed from the business premises by locking the wheels or otherwise preventing the movement of the carts.

C. In its Shopping Cart Containment ordinance, the City of Glendale states that the purpose of the law: “The accumulation of wrecked, dismantled or abandoned shopping carts, or parts thereof, on public property is found to create a condition tending to reduce property values, to promote blight and deterioration, to constitute an attractive nuisance creating a hazard to the health and safety of minors, to be aesthetically detrimental to the community and to be injurious to the health, safety and general welfare. Responsibility for minimizing or eliminating this impact rests with individuals who use shopping carts and the businesses which provide shopping carts for their patrons. Therefore, effective containment or control of the shopping carts shall be mandated, and the presence of wrecked, dismantled or abandoned shopping carts, or parts thereof, on public property, is declared to constitute a public nuisance which may be abated as such in accordance with the provisions of this chapter.” Glendale Municipal Code Chapter 12.32.

D. The City of Carson passed a shopping cart ordinance requiring retailers to submit an “abandoned shopping cart prevention plan” to the City detailing how they intend to address abandoned shopping carts. Additionally, signs identifying the carts must be affixed to the shopping cart and each cart found off store property must be retrieved within 24-hours of notification.

E. The City of Long Beach passed amendments strengthening their existing shopping cart ordinance. The amendments allow the city to fine retailers $100 for each shopping cart found off their property. If the city finds more than 10 shopping carts from one store in a 30-day period, the business will face a hearing with city officials to fix the shopping cart problem. If the carts continue to be a problem, retailers could face criminal prosecution.

F. The City of Ontario passed an ordinance requiring retailers with shopping carts to show proof they have a contract with a retrieval service or a plan to address the issue of abandoned carts.

G. The City of Los Angeles continues to consider similar legislation, based on the following legislative finding: “Throughout the communities of Los Angeles, illegally removed abandoned shopping carts on public and private property are a source of visual blight and constitute a nuisance. City Council Offices receive numerous calls a week from constituents reporting abandoned carts. They can obstruct pedestrian and automobile traffic in the public right of way, creating potential hazards to the health and safety of the general public. Some stores already have policies and procedures in place to deter the illegal removal of carts, including identification, signage, contracts for cart retrieval services and electronic wheel locking systems. While these are all positive steps, as a whole they have so far been proven ineffective, as can be seen by driving through our communities. Some shopping cart retrieval contractors have been known to steal the carts from a store in order to increase cart retrieval profits. Furthermore, the electronic wheel locking system is only an effective deterrent in about 3 out of 4 carts. Therefore, the City should take action to eliminate the visual blight caused by illegally removed shopping carts and to ensure the safety and well being of its residents by comprehensively addressing this issue.”

H. A County of Los Angeles ordinance requiring all businesses operating in the City of Los Angeles that provide more than 10 shopping carts to their customers to submit, with their annual business license application/renewal form, a copy of a certified, valid contract with a cart retrieval company that is licensed to do business in the City of Los Angeles. The cart retrieval company must guarantee pickup within 24 hours of notice. If a business does not send a copy of a certified, valid contract, the City will fine the business $1,000 per month, per location, until the violation is corrected; business license renewals will be denied to locations with unpaid violations. All carts must be clearly identified with the name of the store, including store number if applicable, and a telephone number to call for retrieval. Signage must be posted near customer exits and near parking area exits of the store and on the carts stating to customers that unauthorized removal, use, or possession, of shopping carts is a misdemeanor under Section 41.45 of the Los Angeles Municipal Code.

In addition, consideration has been given to a enacting bill that would require retailers to install electronic cart containment systems that prevent shopping carts from leaving a store's property if the store loses a certain number of carts during a specified period, and will require code enforcement officers to count carts at local stores and, if more than five carts are missing on any given day, requires the stores to devise a way to keep them on the property. This prompted many companies to install electronic systems that cause cart wheels to lock if someone tries to remove them from the parking lot.

I. Finally, one of the more comprehensive local laws, Ordinance No. 1420 of The City Council of The City of Manteca, dated: Oct. 6, 2008, provides the following features:
police have the authority to issue tickets to persons caught pushing shopping carts without written permission of the store
police have the authority to seize carts from violators on the spot
designated municipal employees or volunteers are allowed to collect shopping carts, take them to a central location, and give stores 72 hours to claim them
police have the authority to destroy unclaimed carts
all new stores using shopping carts are required to have systems that lock the wheels whenever an attempt is made to take them off the premises.

Oregon is another state that is regulating the use and recovery of shopping carts. Chapter 243 Oregon Laws 2007 provides “An Act Relating to Shopping Carts,” which requires retailers to post signs advising that taking the carts off the property is a crime; requires that each cart be labeled with the business name and a toll-free phone number to report if it is abandoned; and applies to any retailer with carts, including non-food retailers, which may represent about half the carts in use. When a city adopts an ordinance and is forced to retrieve a cart because a retailer doesn't do so within three days, the city will return the cart after the retailer pays a $50 fine or keep and resell the cart. To date, several Oregon cities have adopted ordinances following this state law.

C. Customer Service Issues.

Applicants have identified a third issue in the management of shopping cart assets, which has not been addressed by the prior art: customer convenience and service. Applicants have not found in the prior art any attempt to address critical customer-relations factors in the design and operation of management systems for shopping carts and other wheeled conveyances. Because all of the solutions to the first and second problems above involve optimizing the ability to prevent a shopping cart or other wheeled conveyance from leaving the business premises, consideration of the needs of customers has been entirely ignored. Indeed, false-positive conditions experienced by locking systems can leave a customer frustrated or even angry when a cart becomes immobilized when used in within a permitted-use area.

Thus, the prior art recognizes that, for any of several reasons, it may be desirable to limit the movement of a shopping cart as it is being used, such as confining or limiting the movement of the shopping cart to within a specifically defined area, or to selectively disable the shopping cart and thereby prevent its further movement outside the defined area. This capability has been thought to be particularly important when the shopping cart or other wheeled conveyance is temporarily loaned or provided to an individual such as a store customer for use only in a defined area such as a shopping center and its contiguous parking lot. In such situations, the overriding objective has been theft prevention.

On the other hand, what the prior art fails to recognize is that it is not only unauthorized use that requires action. The art utterly fails to consider that authorized use is perfectly appropriate in most situations, and there is a great unrecognized and unmet need to satisfy the goal of preventing unauthorized taking while accommodating authorized uses which improve a customer/visitor's shopping experience and thus improve the relationship between an enterprise and its customer/visitor.

### Solutions to Technical Problems

As discussed in greater detail throughout, the inventive subject matter provides a unified solution to all three of these problems through a system in which unauthorized use is limited, while authorized use is both encouraged and appropriately managed in a manner that meets all of the goals of the enterprise: limiting theft, complying with government regulations, and satisfying customer needs.

### SUMMARY OF THE INVENTIVE SUBJECT MATTER

The inventive subject matter relates to systems and methods relating to managing shopping cart and other wheeled conveyance assets of an enterprise. More particularly, in one aspect the inventive subject matter relates to using radio frequency identification (RFID) tags and control units to track, manage, and maintain shopping cart and other wheeled conveyance assets of a enterprise, in order to immobilize such wheeled conveyance if an unauthorized attempt is made to move it outside a prescribed use area into a restricted area. In a further aspect of the inventive subject matter, said systems and methods permit authorized uses of such assets.

Thus, the claimed subject matter relates to a system for controlling engagement and disengagement of an immobilizing mechanism on a cart or similar vehicle, comprising:
a) an RFID tag configured to attach to a shopping cart or similar vehicle, and further configured to send a cart-associated unique identifier signal in response to an interrogation signal;
b) an RFID transceiver configured to send an interrogation signal and to receive said unique identifier signal broadcast from said RFID tag;
c) a computer or similar device, comprising memory having a stored database of user permissions, and configured to communicate with a control unit;
d) a transmitter configured to receive a unique output signal from a control unit and configured to broadcast a unique activation signal to a signal receiver associated with said shopping cart or similar vehicle;
e) a plurality of control units, each configured to detect one unique identifier, further configured to communicate to and receive communications from said computer or similar device, and further configured to communicate a unique output signal to said transmitter;
f) a plurality of control units, each configured to detect one unique identifier, further configured to communicate to and receive communications from said computer or similar device, and further configured to communicate a unique output signal to said transmitter; and
g) a battery or other wireless power source,
   wherein said system serves to immobilize a shopping cart or similar vehicle detected in a restricted zone and not checked out to a permitted user found in said stored database, and wherein said system serves to permit authorized use of a shopping cart or similar vehicle detected in a restricted zone which is checked out to a permitted user found in said stored database.

Additionally, the inventive subject matter relates to a method for controlling engagement and disengagement of an immobilization mechanism on a shopping cart or similar vehicle, comprising the steps of:
a) sending an RFID interrogation signal from an RFID transceiver into a restricted area on or near selected premises;
b) receiving a responsive signal to said interrogation signal from an RFID tag attached to a shopping cart or similar vehicle, comprising a cart-associated unique identifier;
c) upon said RFID transceiver receiving said responsive signal, said RFID transceiver sending a signal comprising said cart-associated unique identifier to a plurality of control units;
d) upon a corresponding control unit receiving a cart-associated unique identifier which corresponds to its activating unique identifier, said corresponding control unit sending data comprising said unique identifier to a computer having an authorized-user database;
e) said computer executing instructions to check said database for an association between user permissions and said cart-associated unique identifier to determine if the shopping cart or similar vehicle associated with the signal is checked out to an authorized user,
f) said computer sending a signal to said corresponding control unit to initiate immobilization if said shopping cart or similar vehicle is not checked out to an authorized user;
g) said corresponding control unit sending a unique output signal to a transmitter to initiate broadcasting a unique activation signal to the shopping cart or similar vehicle in the restricted area;
h) said transmitter broadcasting said unique activation signal to a signal receiver associated with said shopping cart or similar vehicle; and
i) upon receiving said unique activation signal, said signal receiver activating a battery-powered immobilization circuit which operates a physical immobilization mechanism which immobilizes said shopping cart or similar vehicle.

### BRIEF DESCRIPTION OF THE DRAWINGS

FIG. 1 is a conceptual drawing which depicts a system according to one embodiment of the inventive subject matter.

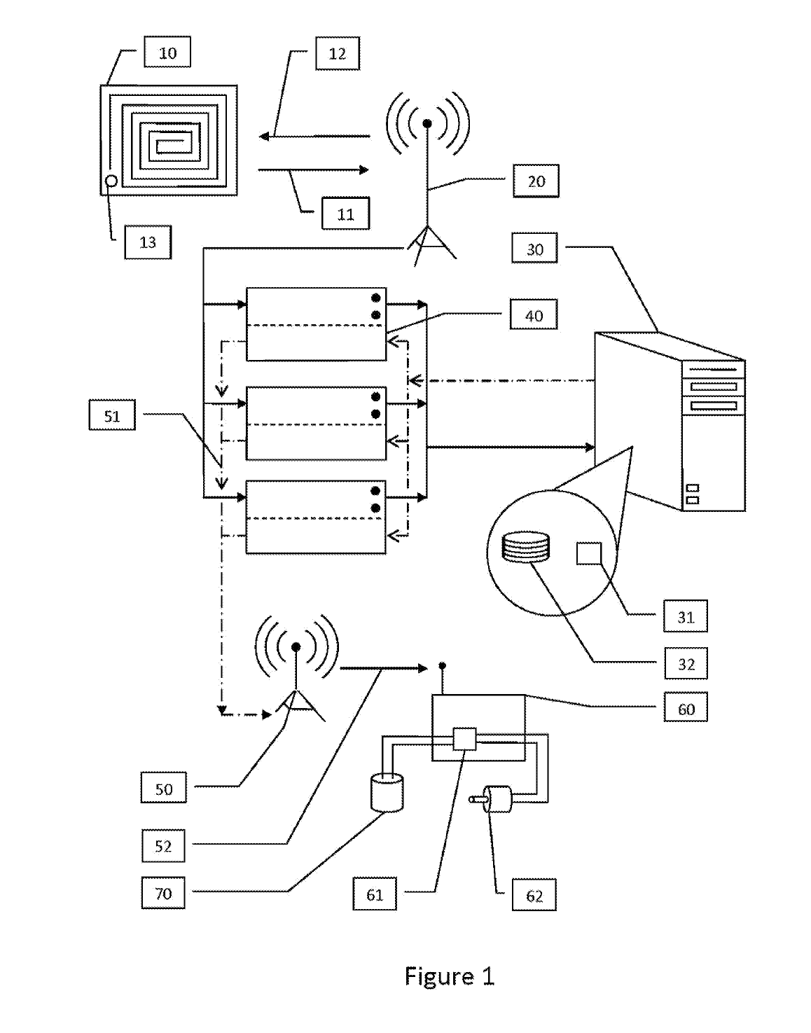

### DETAILED DESCRIPTION OF THE INVENTIVE SUBJECT MATTER

### Definitions

The term “shopping cart” as used herein related to a basket for supporting items to be transported; a frame, typically, although not necessarily, having a four-cornered base coupled with respect to the basket; an upwardly extending handle at one end of the cart; and a plurality of rotatable wheels, typically, although not necessarily, numbering four, provided at the bottom of the cart. A shopping cart within the meaning of the inventive subject matter is also a “wheeled conveyance”, “capital asset”, or “fixed asset” as used herein.

The term “wheeled conveyance” as used herein refers to a class of nonmotorized wheeled conveyances which includes shopping carts and other wheeled carts such as push-carts, baby carriages, bicycles, tricycles, wagons, roller skates, skateboards, wheelchairs, manlifts, manual forklifts, and the like. In addition, the term “wheeled conveyance” further refers to motorized wheeled conveyances including automatic balancing wheeled conveyances, powered forklifts, lawn mowers and similar garden machines, and so forth, having a motor output of less than about 20 bhp.

The term “managed asset” as used herein refers to a class of assets, including “capital assets,” and encompasses durable goods, including shopping carts and other wheeled conveyances, vehicles, and equipment, which are not affixed to land or other fixed property.

The term “tagged asset” as used herein refers to a managed asset to which is affixed a tag associated with an identifier which is unique to the asset. Exemplary tags include, without limitation, bar code, active and passive RFID, and newer technologies such as IEEE standard 1902.1, which is also known as RuBee. RuBee is expected to give retailers and manufacturers an alternative to RFID for many applications, especially item-level tracking efforts, upon its release.

“Enterprise” as used herein refers broadly to a purposeful or industrious undertaking. The term includes, for example, retail shopping such as grocery, department, and discount stores and shopping clubs, and may also refer in its broadest meaning to the management of a home or housing complex, or a recreational facility.

“User” as used herein refers to a person, machine, or mechanized process which manipulates a managed asset or managed asset unit.

### Embodiments of the Inventive Subject Matter

Applications of RFID technology are wide ranging and include detecting objects as they pass near to a sensor, uniquely identifying a specific tag and an associated item, such as a shopping cart or other wheeled conveyance asset, and recovering and/or recording data relating to the tag into an RFID reader for immediate use or later recovery. The process of reading and communicating with an RFID tag generally includes bringing the tag in proximity to an RFID sensor, which can be either a receive-only sensor which detects active tags or a send-receive sensor which sends a signal and receives a responsive signal from a passive tag.

In one aspect, the RFID tags are active tags with an internal power source and emit a constant, or alternatively a pulsed beacon, RF signal. The RFID sensor(s) then detect the tag's emitted RF signal when the signal is within the range of the reader's emitted RF field (or receive range), and the readers receive and process the RF signal emitted by the tags. Thus, the reader detects the presence of an RFID tag by detecting its RF signal, and processes the received RF signal to accurately determine the unique identification code of the tag. An RFID sensor may optionally be used in conjunction with an RFID Real-Time Location System (RTLS) in order to determine and record the location of a tag over time. A series of sensors in an RTLS further provides the ability to detect both the timing of signal receipt in comparison to nearby sensors, as well as the incidence angle of the signal to each sensor. The availability of timing and directional data results in the ability to precisely determine the location of the tag, and its attached asset, in three dimensional space.

Alternatively, in other conventional systems, the RFID tags are passive while not in the presence of a magnetic field generated by an RFID reader and transmitted by the sensors. Once the tag(s) enter such a magnetic field, they transmit relevant tag information back to the reader and host application. In the presence of the magnetic field, a passive RFID tag receives electromagnetic energy and subsequently activates to send data, using any one of several “handshake” forms or protocols between the tag and the reader, in order to exchange data. All of this communication between the tag's transponder and the reader is performed using radio frequency energy of some kind.

A third type of RFID tag is semi-passive. Like active tags, semi-passive tags use internal batteries to power their integrated circuits. An active tag uses its battery to actively and continuously broadcast radio waves to a reader, whereas a semi-passive tag relies on the reader to supply the power to initiate broadcasting and uses the internal battery to boost signal strength and range. Active and semi-passive tags can be read over greater distances—they broadcast at frequencies from 850 to 950 MHz that can be read 100 feet or more away. If it is necessary to read the tags from even farther away, additional batteries can boost a tag's range to over 300 feet.

When multiple passive or semi-passive RFID tags are involved, anti-collision protocols are employed in order to multiplex or provide multiple accesses to the readers by the multiple tags. The main advantages of an RFID reader and transponder system over the other forms of RFID tagging include (i) communication can occur within comparatively harsh operating environments; and (ii) the communication range between the reader and transponder can, in some cases using specially designed RFID technologies, be significant even when the RF frequencies are within the power limitations of the Federal Communications Commission (FCC) rules concerning unlicensed transmitters.

Accordingly, RFID technology is useful for several applications, especially those relating to security and asset management. For example, in an application where enhanced security is desired, RFID systems using electromagnetic energy with very low frequency are attractive since the very low frequency energy tends to suffer low losses from shielding materials such as metal, aluminum foil, curtains, and the like.

Thus, for the reasons discussed above, and others, there is a particular need for RFID-based systems and methods to better track and manage shopping cart and other wheeled conveyance assets of an enterprise.

In one exemplary embodiment relating to shopping carts, which is discussed in this application and claimed in complementary U.S. patent application Ser. No. 11/703,207, filed Feb. 7, 2007, and its parent applications, efficiently managing shopping cart assets similarly requires location identification, as many enterprises have multiple sites and, currently, the whereabouts of shopping cart assets within and outside the business premises of the enterprise are not known, absent a costly and time-consuming physical inventory, and further requiring costly recovery processes for carts which have been taken away from business premises.

In addition, many enterprises would benefit from reducing the quantity of shopping cart assets which must be maintained “on hand,” as better tracking would better define the inventory needed, reducing the number of carts off the business premises and thus effectively out-of-service. As technology continues to advance and the cost of capital assets continues to rise, this will satisfy the goal of many enterprises in keeping minimal shopping cart inventory on hand.

Because of the deficiencies in the prior art relating to shopping cart asset management, as described herein, many enterprises do not efficiently manage their shopping cart assets, particularly failing to effectively track such assets in order to minimize theft, generate customer goodwill, work effectively with local government representatives, and maximize the available data for more effective customer service and targeted marketing.

Thus, in the specific context of retail businesses utilizing shopping carts, there is a need for the ability to track the location of a shopping cart in order to reduce or prevent unauthorized removal of this business asset from business premises, and to permit authorized removal of this business asset from business premises and tracking to a anticipated location. With improvements in RFID technology, there is a particular need for systems and methods to better track and the shopping cart assets of an enterprise. In particular, there are multiple reasons that shopping carts which are better tracked and managed can improve the operation of a business utilizing shopping carts, both to extend the service lifetime of such shopping cart assets and to aid the business in better serving the needs of its customers and local community.

Wheeled Conveyance Asset Management.

The inventive subject matter relates to systems and methods relating to tracking and managing shopping cart or other wheeled conveyance assets of an enterprise. More particularly, the invention relates preferably to using radio frequency identification (RFID) tags to track, manage, and maintain mobile or portable assets of a enterprise.

The inventive subject matter, particularly utilizing RFID, provides a solution to wheeled conveyance asset tracking and management. The implementation of a new system appears to be the limiting issue at present, as most companies do not want a change in the way they conduct their business unless the labor requirement is minimal and the return on investment is substantial enough to make a short-term impact. For example, a shopping cart affixed with an RFID tag provides an efficient and cost effective solution to this concern, with rapid return on investment by reducing cart losses and therefore the amount of cart inventory required. Additionally, in the case of a combination product also including an RTLS, can provide useful marketing data to help increase sales. RFID-based systems in particular also help minimize employee labor during operation.

If the goal of a business operator is simply to prevent a cart leaving the business premises, a number of wheel-locking systems are commercially available. However, as discussed above, such systems are focused on preventing cart theft, and to Applicants' knowledge are uniformly non-discriminating in use. That is, the cart locks or becomes otherwise immobilized upon reaching a certain point, generally the business premises perimeter, and there is no provision for preventing locking in order to allow the cart to be taken off-site with the proprietor's authorization.

An additional factor increasing the usefulness of the inventive subject matter is that many consumers already have customer identification cards, such as membership or customer loyalty cards, which have established features based on the pre-determined roles or permissions granted by the enterprise. In the current best mode of the inventive subject matter, as a shopping cart approaches an established boundary of the business premises for the permitted use of a cart which is not individually authorized, the inventive method implemented by the inventive system, records the date and time, and checks a designated business database to determine if information about the customer using the shopping cart is available. Such customer information can be accessed by scanning an identification card carried by the customer, by entry of the required data through a data entry device, or by another identification-verification process such as checking biometric features.

If the customer attempting to remove the shopping cart is not permitted to do so under the administrative policy of the business, any or all of several actions may take place: the cart can immobilized such as by locking one or more cart wheel(s) to limit the mobility of the cart; an electronic alert notification may be sent to a company employee or automated response system when a cart crosses the boundary and leaves the business premises; an electronic alert notification may be sent to local officials such as the police when a cart crosses the boundary and leaves the business premises; a visual and/or auditory alarm may be displayed on the cart or nearby on the business premises; or some combination of the above may take place.

On the other hand, if the customer is authorized to take a cart off-premises, the system may be configured so that either
no action takes place, or
only action not apparent to the customer takes place, such an triggering an electronic notification, for example a text message, to be sent to a company employee or automated system responsible for tracking carts which are charged out to customers.

In another aspect, the inventive systems and methods function to direct employees to the location of an asset item scheduled for replacement, repair or maintenance, or which must be recovered from off the business premises. The specific location where the asset is stored may be found, for example, through a wireless device such as a telephone with RFID capabilities, which can locate the unique identifier associated with each such wheeled conveyance. This will reduce the amount of time currently spent searching for such assets, and this is particularly important in the case of shopping carts because of the government regulation issues discussed above.

Thus, an object of the inventive subject matter is to provide a shopping cart inventory, security, and tracking system which is programmable to permit shopping carts to leave the business premises with an authorized user.

### Inventive Systems

The inventive subject matter additionally relates to a system for controlling engagement and disengagement of an immobilizing mechanism on a cart or similar vehicle, comprising:
a) an RFID tag (10) configured to attach to a shopping cart or similar vehicle, and further configured to send a cart-associated unique identifier signal (11) in response to an interrogation signal (12);
b) an RFID transceiver (20) configured to send an interrogation signal (12) and to receive said unique identifier signal (11) broadcast from said RFID tag;
c) a computer or similar device (30), comprising memory having a stored database of user permissions (32), and configured to communicate with a control unit (40);
d) a transmitter (50) configured to receive a unique output signal (51) from a control unit and configured to broadcast a unique activation signal (52) to a signal receiver (60) associated with said shopping cart or similar vehicle;
e) a plurality of control units (40), each configured to detect one unique identifier, further configured to communicate to and receive communications from said computer or similar device, and further configured to communicate a unique output signal (51) to said transmitter (50); and
f) a battery (70) or other wireless power source,
   wherein said system serves to immobilize a shopping cart or similar vehicle detected in a restricted zone and not checked out to a permitted user found in said stored database, and wherein said system serves to permit authorized use of a shopping cart or similar vehicle detected in a restricted zone which is checked out to a permitted user found in said stored database.

In one aspect of the inventive subject matter, said RFID tag is a semi-passive RFID tag having a battery (13).

In another aspect of the inventive subject matter, said RFID transceiver and said plurality of control units, said plurality of control units and said computer, said plurality of control units and said transmitter, and said signal receiver and said battery-powered immobilization circuit is each independently operably connected via a wireless connection or a hard-wired connection.

In a further aspect of the inventive subject matter, said wireless connection comprises a radio frequency signal transmitted between a wireless transmitter and a wireless receiver. In a preferred embodiment, said wired connection comprises a network cable. In a second preferred embodiment, said transmitter comprises a wireless radio frequency transmitter.

In an additional aspect of the inventive subject matter, said computer or similar device has a central processing unit (31) for executing instructions, and is programmed with at least the following instructions:

a) to query said database for an association between a permitted user and said cart-associated unique identifier,

b) to take no action to generate an output signal if said association is found in said database, and

c) to communicate with said control unit to generate and communicate said unique output signal to said transmitter if such said association is found in said database.

Said computer is optionally a general purpose computer or a specialty device, in addition to memory and a processor, having input and output devices for data entry and review, and ports for external communications.

In another aspect of the inventive subject matter, wherein upon receiving its unique activation signal, said signal receiver associated with said shopping cart or similar vehicle activates said battery-powered locking circuit comprising a relay (61) and solenoid (62), wherein said solenoid operates a immobilizing mechanism (not shown) which immobilizes said shopping cart or similar vehicle. In a preferred embodiment, said immobilizing mechanism is a wheel-locking device.

### Inventive Methods

The inventive subject matter relates to a method for controlling engagement and disengagement of an immobilization mechanism on a shopping cart or similar vehicle, comprising the steps of:
a) sending an RFID interrogation signal from an RFID transceiver into a restricted area on or near selected premises;
b) receiving a responsive signal to said interrogation signal from an RFID tag attached to a shopping cart or similar vehicle, comprising a cart-associated unique identifier;
c) upon said RFID transceiver receiving said responsive signal, said RFID transceiver sending a signal comprising said cart-associated unique identifier to a plurality of control units;
d) upon a corresponding control unit receiving a cart-associated unique identifier which corresponds to its activating unique identifier, said corresponding control unit sending data comprising said unique identifier to a computer having an authorized-user database;
e) said computer executing instructions to check said database for an association between user permissions and said cart-associated unique identifier to determine if the shopping cart or similar vehicle associated with the signal is checked out to an authorized user,
f) said computer sending a signal to said corresponding control unit to initiate immobilization if said shopping cart or similar vehicle is not checked out to an authorized user;
g) said corresponding control unit sending a unique output signal to a transmitter to initiate broadcasting a unique activation signal to the shopping cart or similar vehicle in the restricted area;
h) said transmitter broadcasting said unique activation signal to a signal receiver associated with said shopping cart or similar vehicle; and
i) upon receiving said unique activation signal, said signal receiver activating a battery-powered immobilization circuit which operates a physical immobilization mechanism which immobilizes said shopping cart or similar vehicle.

In accord with the present inventive subject matter, an immobilizing device such as a wheel-locking mechanism is controllable. In one aspect, such control is exercised by a store employee having the appropriate permissions or roles to access the system. In a preferred embodiment, the control of a wheel-locking mechanism is optionally linked to a customer loyalty card and/or membership database, in which the customer may be permitted off-site use of shopping carts. In this aspect, the inventive system would serve the function of checking or charging out a shopping cart to a particular customer. In one embodiment, the number of carts permitted to be checked out to one customer would be limited, and the customer would optionally be required to return a borrowed shopping cart before taking another.

In another aspect of the inventive subject matter, it is determined from said database if said user has permission to pass said pre-established boundaries, and identifier designating the cart or other vehicle associated with said user is recorded in said database as checked out to said user for a pre-determined period of time. In a preferred embodiment, a “return or extend” reminder is sent to said user when said pre-determined period of time has expired. In a more preferred embodiment, said reminder is sent via email to said user in order to improve efficiency and reduce employee time expenditure. In a most preferred embodiment, said user is permitted to extend said pre-determined period of time via a device-to-device request transmitted over a network of interconnected devices, such as computers, PDAs, web-enabled phones, and the like.

Utilizing long range tracking capability, the business owner would be able to track its tagged shopping cart assets off-site. In addition, the business owner, or its cart collection agent, would be able to locate its tagged shopping cart assets and decide whether to collect and return them, or wait for the customer to have the opportunity to do so. Such tagging and tracking capability, having a unique identifier for each cart, would also make is possible for each cart to be located at will and returned to its true owner, and in particular to comply with government regulations requiring recovery of shopping carts within a specified time.

In a further preferred embodiment, the method additionally comprises monitoring said pre-established boundaries for a cart or other vehicle recorded in said database as checked out to a user, and recording said cart or other vehicle as returned upon said cart or other vehicle crossing the pre-established boundary back onto the business premises.

An Exemplary Immobilizing Device.

In a further embodiment of the inventive systems and methods, an exemplary immobilizing device relates to a locking wheel assembly, to be attached to a cart or similar vehicle, comprising:

a) a substantially cylindrical wheel housing which is closed on a first end and open on a second end, said wheel housing having one or more through-going holes in said closed end to accommodate a corresponding number of linkage pin(s);

b) a linkage plate having one or more linkage pins corresponding to said through-going hole(s) in said wheel housing;

c) a base plate having two sides, which when attached to said open end of said wheel housing produces a substantially closed cylinder enclosing an interior space, wherein a first side of said base plate faces said interior space and a second side of said base plate forms an outer surface of said substantially closed cylinder;

d) a motor assembly;

e) a linkage assembly, located within said interior space, powered by said motor assembly, and operably connecting said linkage plate and said first side of said base plate; and

f) a circuit board/receiver assembly operably attached to said motor assembly to control said motor,

wherein said motor assembly drives said linkage assembly to deploy the linkage pin(s) on said linkage plate to penetrate the corresponding through-going hole(s) in said wheel housing.

In one aspect of such immobilizing device, said wheel housing and said base plate each have a through-going hole to accommodate an axle. In a preferred embodiment, said locking wheel assembly is attached to a cart or similar vehicle via a wheel yoke and an axle.

In another aspect of such immobilizing device, said linkage assembly comprises

a) a linkage base plate, and

b) a plurality of links,

wherein said plurality of links comprises one or more scissor mechanism(s) for deploying and withdrawing said linkage pin(s) from the corresponding through-going hole(s) in said wheel housing.

In a further aspect of such immobilizing device, said motor assembly comprises

a) a motor, and

b) a gear subassembly operably attached to said motor.

In a preferred embodiment, said motor is attached to the first side of said base plate. In another preferred embodiment, said gear subassembly is attached to the first side of said base plate.

In another aspect of such immobilizing device, circuit board/receiver assembly comprises an electronic circuit board operably connected to an RFID receiver. In a preferred embodiment, said RFID receiver is configured to operate in a host system operating at 2.4 GHz ultra-wide band (UWB) frequency range. In another preferred embodiment, said electronic circuit board is attached to the first side of said base plate. In a further preferred embodiment, said receiver is attached to the second side of said base plate.

In an alternate aspect of such immobilizing device, the cylindrical wheel housing has a hard rubber tire. In a preferred embodiment, the cylindrical wheel housing is in one or two pieces and composed of a plastic composition selected from the group consisting of polystyrene, high-impact polystyrene, polyvinyl chloride, acrylonitrile butadiene styrene, polypropylene, and combinations thereof. In a more preferred embodiment, the cylindrical wheel housing is composed of acrylonitrile butadiene styrene (ABS plastic).

In another aspect of such immobilizing device, the wheel assembly additionally comprises a power source. In a preferred embodiment, said power source is a battery which is optionally rechargeable.

### EXAMPLES AND ADDITIONAL EMBODIMENTS OF THE INVENTIVE SUBJECT MATTER

The following examples are illustrative of the inventive subject matter and are not intended to be limitations thereon.

### Example 1

### Best Mode Example

In Applicants' best mode embodiment of the inventive systems and methods comprise the following activities and logical decision points:

In this embodiment, an RFID transceiver mounted on the exterior of a structure sends an interrogation signal covering a restricted area around or near the building. Such a structure is most likely a business premises, but can also be a residence or locates in association with a recreational facility. The interrogation signal is optionally continuous or periodic/intermittent, depending on the degree of certainty in detecting all RFID tags within said restricted area. When “pinged” with an interrogation signal in a restricted zone, an RFID tag attached to a shopping cart or similar vehicle will respond to the interrogation signal by broadcasting a response comprising its cart-associated unique identifier.

In this embodiment, upon receiving a response to its interrogation signal, the RFID transceiver sends a signal, either via a network cable such as an “RJ45” or similar cable, or via wireless communication, to an in-structure “Command Center”, such as the customer service desk or Manager's Office for a retail business. The RFID transceiver will send such a signal for each cart-associated unique identifier which it receives from an RFID tag, in response to an interrogation signal in a restricted zone. In this embodiment, each of a plurality of control units in the Command Center receive each unique identifier from the RFID transceiver. Each of the control units is uniquely associated with only one RFID tag unique identifier, and a match between a cart-associated unique identifier and its corresponding control unit triggers that unit to send a signal, for example via a hard-wire connection or via an RF signal using a 315 MHz, 433 MHz, or comparable RF connection, to a computer.

In this embodiment, the computer comprises memory which hosts a database associating individual users, who are customers in this example but can also be users of any type applicable to a business, residence, recreational facility, and so forth, with permissions granted to use a shopping cart or similar vehicle in the restricted area. For example, a retail store may wish to grant permission to a customer to check out a shopping cart for a period of time, and this permission-information would be entered in the database by a store employee. In this embodiment, the computer then executes its instructions, in which each cart-associated unique identifier is checked against the database of user permissions to determine if the cart associated with the signal from a restricted zone is checked out to a user. If the cart is checked out to a user, as discussed above, the computer may be programmed to take no action and permit the cart to pass into and through the restricted area, or the computer may optionally be programmed to record information relating to the event.

In this embodiment, if the cart is not checked out to a user, the computer sends a signal, for example via a hard-wire connection or via an RF signal using a 315 MHz, 433 MHz, or comparable RF connection, to the corresponding control unit to initiate an immobilization sequence, such as locking a cart wheel to prevent the cart from rolling. In this embodiment, the corresponding control unit in turn sends instructions, again optionally via a hard-wire connection or via an RF signal using a 315 MHz, 433 MHz, or comparable RF connection, to an RF transmitter, which can optionally be an RFID transmitter, to broadcast a unique activation signal to the shopping cart in the restricted zone.

In this embodiment, a signal receiver associated with the shopping cart which is in a restricted zone receives its unique activation signal and activates a battery-powered immobilization circuit. In this embodiment, the battery-powered immobilization circuit comprises a relay and a solenoid. When energized, the solenoid operates a physical mechanism which immobilizes the cart. The mechanism for immobilizing the cart is a cart wheel lock, but the claimed inventive subject matter is not so limited.

### Example 2

### Exemplary Shopping Cart Tracking and Management

Most retail businesses provide shopping carts, push-carts, baby carriages, wheelchairs, or other similar wheeled conveyances for the convenience of their customers in transporting merchandise, children, or themselves through the stores and to the customer's vehicles. A shopping cart, or other wheeled conveyance as exemplified above, is tagged with an RFID tag having a unique identifier. The RFID tag is readable by an RFID sensor attached to a system having a database to correlate each unique identifier with information relating to the shopping cart, such as the identity of the user of the cart, the “base” location of the cart, and the like. The RFID reader system is any one of those known to a skilled RFID systems engineer, including but not limited to a preferred long range system such as the “Wi-max” system.

Once the customer has checked out and is ready to leave the business premises, the business operator optionally may make a decision as to whether or not to permit the customer to continue to use the shopping cart off the business premises. Some businesses may, as a customer service, wish to permit or even encourage the customer to take his/her purchases home in a shopping cart, for example in the cases of the elderly or otherwise impaired, or simply those without personal transportation. Applicants believe that when a particular cart is “checked out” to a particular customer, that customer will be significantly more like to take responsibility for maintaining and returning the cart. Additional customer responsibility may be encouraged by a reward system for responsible cart management, such as one or more of charging a refundable cart deposit and providing a discount or other incentive for returning a checked-out cart.

### Example 3

### Improved Theft Detection and Recovery

Another benefit of a tracking system, such as an RFID application, for asset or inventory tracking is beneficial for enterprises whose consumers may be using enterprise assets without permission. By placing an RFID tag on an asset, the asset can be identified from the exterior of a building, whether residence or business. As cart recovery efforts routinely cover service certain areas, an RFID reader could be configured to read shopping cart tags while on a route, and to cross reference the tag identifier with a GPS interface, thus providing a report for an employee to use in locating and recovering missing carts.

### Example 4

### Improved Loss Prevention

Another benefit of having the an asset tracking system, such as RFID tags, on an inventory/asset item is the ability to trace specific items. For example, a periodic scan of all carts on the business premises reveals that a cart expected to be on the premises is not, then an alert or other message or communication is sent to prevent loss or trigger recovery efforts of the item. This would reduce losses of such items and avoid spending time searching for the item on the business premises.

### Example 5

### Management of Other Wheeled Conveyances

Enterprises other than retail and discount stores have wheeled conveyances which also should be managed for best performance of the business. In addition to shopping carts and similar wheeled conveyances used by store customers, other variations in the precise type and configuration of wheeled conveyance, the nature of the enterprise, and goal(s) of the asset owner, are possible. Numerous modifications and variations in the inventive subject matter are contemplated to be within the scope of the inventive subject matter.

Rental Shops.

For example, a bicycle shop, resort rental shop, or beach rental shop might have any or all of bicycles, tricycles, skateboards, wagons, roller skates, golf carts, and automatic balancing wheeled conveyances available for guest use or customer rental. Such enterprises generally have defined areas for use of their assets, and it would be beneficial for the business to be able to limit usage as appropriate, to discourage theft or abandonment, and to encourage responsible use. The inventive apparatus, and corresponding systems, methods, and computer programs can provide asset restrictions, tracking, and recovery as needed, and as described in greater detail above. While some of the wheeled conveyances of such enterprises are structurally distinct from carts and thus the configuration of the wheel lock itself may be different than described herein, conceptually an apparatus which can be configured to lock one or more wheels of a rolling asset upon unauthorized use beyond a set boundary, and correspondingly which can be configured to remain unlocked upon authorized use, provides the same benefits to the business owner. In each case, a system as described herein will provide greater inventory control and diminished losses to an enterprise employing an equivalent of the inventive apparatus, or a corresponding system, method, and computer program.

Equipment Rental.

For example, an equipment rental shop might have manlifts, manual forklifts, powered forklifts, lawn mowers, wheel barrows, and other wheeled garden equipment and machines, as well as other equipment, available for rental. As such enterprises may be very busy at times, the ability to reduce losses from theft and inability to locate assets in crowded business premises can be important to such an enterprise. One problem that many of these establishments experience is substantial financial burdens through the loss of such assets, be it through outright theft or simple unauthorized removal from the premises and negligent abandonment. As above, while some of the wheeled conveyances of such enterprises are structurally distinct from carts and thus the configuration of the wheel lock itself may be different than described herein, conceptually an apparatus which can be configured to lock one or more wheels of a rolling asset upon unauthorized use beyond a set boundary, and correspondingly which can be configured to remain unlocked upon authorized use, provides similar benefits. In each case, a system as described herein will provide greater inventory control and diminished losses to an enterprise employing an equivalent of the inventive apparatus, or a corresponding system, method, and computer program.

Similar features and benefits are fully expected to accrue to many other enterprises which have wheeled assets which must be managed. Hotels, airports, and vehicle rental facilities can better manage luggage carts. Apartment and condominium complexes can better manage wheeled assets such as portable grills, patio furniture, and loaner moving equipment such as hand-trucks and dollies. Even individual homeowners can better manage wheeled assets such as bicycles, tricycles, wagons, trash and recycling receptacles, garden equipment, power tools, and the like.

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the inventive subject matter as described herein.

1. A system for controlling engagement and disengagement of an immobilizing mechanism on a cart or similar vehicle, comprising:
a) an RFID tag configured to attach to a shopping cart or similar vehicle, and further configured to send a cart-associated unique identifier signal in response to an interrogation signal;
b) an RFID transceiver configured to send an interrogation signal and to receive said unique identifier signal broadcast from said RFID tag;
c) a computer or similar device, comprising memory having a stored database of user permissions, and configured to communicate with a control unit;
d) a transmitter configured to receive a unique output signal from a control unit and configured to broadcast a unique activation signal to a signal receiver associated with said shopping cart or similar vehicle;
e) a plurality of control units, each configured to detect one unique identifier, further configured to communicate to and receive communications from said computer or similar device, and further configured to communicate a unique output signal to said transmitter;
f) a plurality of control units, each configured to detect one unique identifier, further configured to communicate to and receive communications from said computer or similar device, and further configured to communicate a unique output signal to said transmitter; and
g) a battery or other wireless power source,
wherein said system serves to immobilize a shopping cart or similar vehicle detected in a restricted zone and not checked out to a permitted user found in said stored database, and wherein said system serves to permit authorized use of a shopping cart or similar vehicle detected in a restricted zone which is checked out to a permitted user found in said stored database.

2. The system of claim 1, wherein said RFID tag is a semi-passive RFID tag.

3. The system of claim 1, wherein said RFID transceiver and said plurality of control units, said plurality of control units and said computer, said plurality of control units and said transmitter, and said signal receiver and said battery-powered immobilization circuit is each independently operably connected via a wireless connection or a hard-wired connection.

4. The system of claim 3, wherein said wireless connection comprises a radio frequency signal transmitted between a wireless transmitter and a wireless receiver.

5. The system of claim 3, wherein said wired connection comprises a network cable.

6. The system of claim 1, wherein said transmitter comprises a radio frequency transmitter.

7. The system of claim 1, wherein said computer or similar device is programmed with at least the following instructions:
a) to query said database for an association between a permitted user and said cart-associated unique identifier,
b) to take no action to generate an output signal if said association is found in said database, and
c) to communicate with said control unit to generate and communicate said unique output signal to said transmitter if such said association is found in said database.

8. The system of claim 1, wherein upon receiving its unique activation signal, said signal receiver associated with said shopping cart or similar vehicle activates said battery-powered locking circuit comprising a relay and solenoid,
wherein said solenoid operates a immobilizing mechanism which immobilizes said shopping cart or similar vehicle.

9. The system of claim 8, wherein said immobilizing mechanism is a wheel-locking device.

10. A method for controlling engagement and disengagement of an immobilization mechanism on a shopping cart or similar vehicle, comprising the steps of:
a) sending an RFID interrogation signal from an RFID transceiver into a restricted area on or near selected premises;
b) receiving a responsive signal to said interrogation signal from an RFID tag attached to a shopping cart or similar vehicle, comprising a cart-associated unique identifier;
c) upon said RFID transceiver receiving said responsive signal, said RFID transceiver sending a signal comprising said cart-associated unique identifier to a plurality of control units;
d) upon a corresponding control unit receiving a cart-associated unique identifier which corresponds to its activating unique identifier, said corresponding control unit sending data comprising said unique identifier to a computer having an authorized-user database;
e) said computer executing instructions to check said database for an association between user permissions and said cart-associated unique identifier to determine if the shopping cart or similar vehicle associated with the signal is checked out to an authorized user,
f) said computer sending a signal to said corresponding control unit to initiate immobilization if said shopping cart or similar vehicle is not checked out to an authorized user;
g) said corresponding control unit sending a unique output signal to a transmitter to initiate broadcasting a unique activation signal to the shopping cart or similar vehicle in the restricted area;
h) said transmitter broadcasting said unique activation signal to a signal receiver associated with said shopping cart or similar vehicle; and
i) upon receiving said unique activation signal, said signal receiver activating a battery-powered immobilization circuit which operates a physical immobilization mechanism which immobilizes said shopping cart or similar vehicle.

11. The method of claim 10, wherein said RFID transceiver and said plurality of control units, said plurality of control units and said computer, said plurality of control units and said transmitter, and said signal receiver and said battery-powered immobilization circuit is each independently operably connected via a wireless connection or a wired connection.

12. The method of claim 11, wherein said wireless connection comprises a radio frequency signal transmitted between a wireless transmitter and a wireless receiver.

13. The method of claim 11, wherein said wherein said wired connection comprises a network cable.

14. The method of claim 10, wherein said transmitter comprises a radio frequency transmitter.

15. The method of claim 10, wherein said computer or similar device is programmed with instructions to query said database for an association between a permitted user and said cart-associated unique identifier, to take no action to generate an output signal if said association is found in said database, and to communicate with said control unit to generate and communicate said unique output signal to said transmitter if such said association is found in said database.

16. The method of claim 10, wherein said immobilizing mechanism is a wheel-locking device.

17. The method of claim 10, wherein said corresponding control unit communicates with said transmitter via an RFID transmission.

18. (canceled)

19. (canceled)

20. An apparatus comprising the following elements operably connected:
a) an RFID transceiver configured to receive a signal containing a unique identifier broadcast from an RFID tag;
b) a computer or similar device having a processor and comprising memory having a stored user permissions database and having executable instructions for querying said database for an association between a permitted user and said unique identifier;
c) a transmitter configured to receive a unique output signal from a control unit and configured to broadcast a unique activation signal; and
d) a plurality of control units, each configured to detect one unique identifier, further configured to communicate to and receive communications from said computer or similar device, and further configured to communicate a unique output signal to said transmitter.

21. The apparatus of claim 20, wherein said RFID transceiver is further configured to send an RFID interrogation signal.

22. The apparatus of claim 20, wherein said executable instructions, when executed by said processor, cause said computer or similar device to query said database for an association between a permitted user and said unique identifier; and
a) to take no action to generate an output signal if said association is not found in said database, or
b) to communicate with a control unit to generate and broadcast a unique output signal if such association is found in said database.

23. The apparatus of claim 20, wherein said unique activation signal is broadcast to a signal receiver associated with a shopping cart or similar wheeled vehicle.

24. The apparatus of claim 20, wherein said unique output signal is processed to immobilize a shopping cart or similar vehicle detected in a restricted zone and not checked out to a permitted user found in said stored database, and
wherein said apparatus serves to permit an authorized use of a shopping cart or similar vehicle detected in a restricted zone which is checked out to a permitted user found in said stored database.

25. A wheeled conveyance comprising:
a) an RFID tag configured to receive an interrogation signal and to send a unique identifier signal associated with said wheeled conveyance in response to said interrogation signal;
b) a receiver configured to receive a unique activation signal;
c) an immobilizing mechanism for immobilizing said wheeled conveyance; and
d) a battery or other wireless power source.

26. The wheeled conveyance of claim 25, wherein said immobilizing mechanism is a wheel-locking device.

27. The wheeled conveyance of claim 26, wherein said wheel-locking device comprises a battery-powered locking circuit comprising a relay and solenoid.

28. The wheeled conveyance of claim 25, wherein said wheeled conveyance serves to immobilize a shopping cart or similar vehicle detected in a restricted zone and not checked out to a permitted user found in a stored database of permitted users, and wherein said wheeled conveyance serves to permit authorized use of a shopping cart or similar vehicle detected in a restricted zone which is checked out to a permitted user found in said stored database.
